(19) United States
(12) Patent Application Publication
(10) Pub. No.: US 2022/0292058 A1
(43) Pub. Date: Sep. 15, 2022

(54) SYSTEM AND METHODS FOR ACCELERATED CREATION OF FILES IN A FILESYSTEM

(71) Applicant: KOMPRISE INC., CAMPBELL, CA (US)

(72) Inventors: JAYALAKSHMI PATTABIRAMAN, CAMPBELL, CA (US); MEHDI NAZEMI, CAMPBELL, CA (US)

(73) Assignee: KOMPRISE, INC., CAMPBELL, CA (US)

(21) Appl. No.: 17/686,142

(22) Filed: Mar. 3, 2022

Related U.S. Application Data
(60) Provisional application No. 63/158,728, filed on Mar. 9, 2021.

(51) Int. Cl. G06F 16/16; G06F 16/11; G06F 16/176; G06F 16/182

(52) U.S. Cl. CPC G06F 16/16; G06F 16/122; G06F 16/176; G06F 16/182

(57) ABSTRACT

An electronic file storage system has a processor. A memory is coupled to the processor, the memory storing program instructions, wherein the program instructions when executed by the processor, causes the processor to: implement a special control request that creates a file and updates attributes of the file.

### RELATED APPLICATIONS

This patent application is related to U.S. Provisional Application No. 63/158,728 filed Mar. 9, 2021, entitled “SYSTEM AND METHODS FOR ACCELERATED CREATION OF FILES IN A FILESYSTEM” in the name of the same inventors, and which is incorporated herein by reference in its entirety. The present patent application claims the benefit under 35 U.S.C § 119(e).

### TECHNICAL FIELD

The present application generally relates to file storage systems, and more specifically, to a system and method for the useful operations on metadata and data of files in file storage systems where large-scale creation of many files is required, as is the case for mass copy, migration, replication, move, or move.

### BACKGROUND

Operations such as mass copy, migration, replication, move, or move in the style of U.S. Pat. No. 10,198,447, without loss of generality heretofore referred to as copy, are generally performed through file system protocols. These protocols can convey complex information and can be driven by a variety of applications in diverse ways. These protocols may also be filled with requirements of persistence and consistency that can enforce serialization of parallel operations. In particular, creating new entities in the directory manifest of a directory-based file system generally locks the directory against multiple creations of new files or subdirectories in the directory. Furthermore, these protocols as exercised within the underlying filesystem may include aspects with high latency somewhere between the protocol interface and the eventual persistence of the file.

Hence the performance of mass copy of a tree of directories and files may be depressed significantly due to (a) the many operations required to write each single file, (b) the latencies within the filesystem, and (c) the serialization required to add each file to the directory manifest. Without loss of generality, the term copy is used to mean copy, migration, replication, move, or move in the style of U.S. Pat. No. 10,198,447. Also, without loss of generality, the file being created is used to mean the file, subdirectory, special file, or other content of the directory being created.

Therefore, it would be desirable to provide a system and method that overcomes the above. The system and method would implement a special control request in a filesystem to support creation of a file. The system and method would implement a special control request that creates a file and also updates attributes of the file.

### SUMMARY

In accordance with one embodiment, an electronic file storage system is disclosed. The electronic file storage system has a processor. A memory is coupled to the processor, the memory storing program instructions, wherein the program instructions when executed by the processor, causes the processor to: implement a special control request that creates a file and also update attributes of the file.

In accordance with one embodiment, an electronic file storage system is disclosed. The electronic file storage system has a processor. A memory is coupled to the processor, the memory storing program instructions, wherein the program instructions when executed by the processor, causes the processor to: implement a special control request that creates at least one file and update attributes of the at least one file in a single call, wherein the special control request is one of: a standard input/output control to a filesystem, a IOCtl call to the filesystem or through a socket channel established between an application and a filesystem.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is an exemplary embodiment of an electronic system for creating files in a filesystem in accordance with one embodiment of the present application;

FIG. 2 an exemplary embodiment of a computer engine used in the electronic system of FIG. 1 in accordance with one embodiment of the present application; and

FIG. 3 is an exemplary embodiment showing example connections and ordering of operations in the electronic system of FIG. 1 in accordance with one embodiment of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Specific embodiments of the invention will now be described in detail with reference to the accompanying figures. Like elements in the figures are denoted by like reference numerals for consistency.

In the following detailed description of embodiments of the invention, numerous specific details may be set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more novel electronic file and object analysis and management systems and methods of operating such novel systems. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

Moreover, for the purpose of describing the invention, an “electronic system,” a “computing unit,” and/or a “main computing unit” are each defined as electronic-circuit hardware device, such as a computer system, a computer server, a data storage unit, or another electronic-circuit hardware unit controlled, managed, and maintained by a file migration module, which is executed in a CPU and a memory unit of the electronic-circuit hardware device for the electronic file migration management.

In addition, for the purpose of describing the invention, a term “computer server” is defined as a physical computer system, another hardware device, a software and/or hardware module executed in an electronic device, or a combination thereof. For example, in context of an embodiment of the invention, a “computer server” is dedicated to executing one or more computer programs for executing and maintaining a robust and efficient file and object management system among varieties of storage systems. Furthermore, in one embodiment of the invention, a computer server is connected to one or more data networks, such as a local area network (LAN), a wide area network (WAN), a cellular network, and the Internet.

Embodiments of the exemplary system and method disclose a system and method for creating and writing files in a filesystem using a filesystem protocol. Without loss of generality, copy is used to mean copy, migration, replication, move, or move in the style of U.S. Pat. No. 10,198,447. Also, without loss of generality, the file being created is used to mean the file, subdirectory, special file, or other content of the directory being created.

Embodiments of the exemplary system and method disclose a system and method that implements a special control request in the filesystem to support creation of a file.

Another embodiment of the exemplary system and method conveys in the special control request a source of file attributes that the special control request should apply onto the file. These attributes could be communicated through the control request, through the attributes of a source file, through a special file, or through some other means.

Another exemplary embodiment of the system and method allows batch creation of multiple files through a single special control request.

Another exemplary embodiment of the system and method makes a mass update of the directory manifest with the batch of files created by the single special control request.

Another exemplary embodiment of the system and method recognizes the boundary of the batch of files to be created to be the end of the directory in which the files are being created.

Another exemplary embodiment of the system and method recognizes the boundary of the batch of files to be created to be a particular total count of files to be created.

Another exemplary embodiment of the system and method recognizes the boundary of the batch of files to be created to be a particular total size of files to be created.

Another exemplary embodiment of the system and method returns the success of each file in the batch create request through a return value of the special request, a bitmap returned by the special request, a special output file, or some other means.

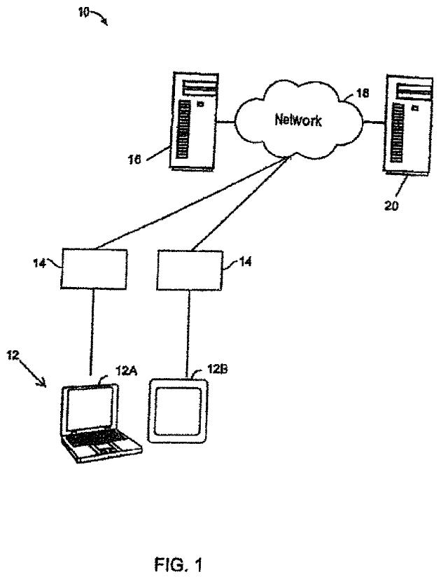

Referring to FIG. 1, a system 10 may be seen. The system 10 may be configured for creating and writing files in a filesystem using a filesystem protocol. The components of the system 10 may be coupled through wired or wireless connections.

The system 10 may have one or more computing engines 12. The computing engines 12 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The computing engine 12 may be described in the general context of computer system executable instructions, such as program modules, being executed by a computer system as may be described below.

The computing engines 12 may be loaded with an operating system 14, The operating system 14 of the computing engine 12 may manage hardware and software resources of the computing engine 12 and provide common services for computer programs running on the computing engine 12.

The computing engines 12 may be coupled to a computer server 16 (hereinafter server 16). The server 16 may be used to store data files, programs and the like for use by the computing engines 12. The computing engines 12 may be connected to the server 16 through a network 18. The network 18 may be a local area network (LAN), a general wide area network (WAN), wireless local area network (WLAN) and/or a public network. In accordance with one embodiment, the computing engines 12 may be connected to the server 16 through a network 18 which may be a LAN through wired or wireless connections.

The system may have one or more additional servers 20. The servers 20 may be coupled to the server 16 and/or the computing devices 12 through the network 18. The network 18 may be a local area network (LAN), a general wide area network (WAN), wireless local area network (WLAN) and/or a public network. In accordance with one embodiment, the server 16 may be connected to the servers 20 through the network 18 which may be a WAN through wired or wireless connections.

The servers 20 may be used for analysis and storage of data. The server 20 may be any data storage devices/system. In accordance with one embodiment, the server 20 may be cloud data storage. Cloud data storage is a model of data storage in which the digital data is stored in logical pools, the physical storage may span multiple servers (and often locations), and the physical environment is typically owned and managed by a third-party hosting company. However, as defined above, cloud data storage may be any type of data storage device/system.

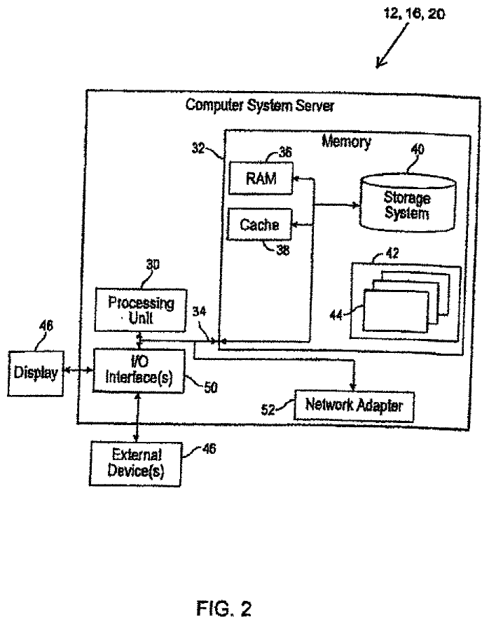

Referring now to FIG. 2, the computing devices 12 and/or servers 16, 20 may be described in more detail in terms of the machine elements that provide functionality to the systems and methods disclosed herein. The components of the computing devices 12 and/or servers 16, 20 may include, but are not limited to, one or more processors or processing units 30, a system memory 32, and a system bus 34 that couples various system components including the system memory 32 to the processor 30. The computing devices 12 and/or servers 16, 20 may typically include a variety of computer system readable media. Such media may be chosen from any available media, including non-transitory, volatile and non-volatile media, removable and non-removable media. The system memory 32 could include one or more personal computing system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein.

The computing device 12 and/or servers 16, 20 may communicate with one or more external devices 46 such as a keyboard, a pointing device, a display 48, or any similar devices (e.g., network card, modern, etc.). The display 48 may be a Light Emitting Diode (LED) display, Liquid Crystal Display (LCD) display, Cathode Ray Tube (CRT) display and similar display devices. The external devices 46 may enable the computing devices 12 and/or servers 16, 20 to communicate with other devices. Such communication may occur via Input/Output (I/O) interfaces 50. Alternatively, the computing devices and/or servers 18, 20 may communicate with one or more networks 18 such as a local area network (LAN), a general wide area network (WAN), and/or a public network via a network adapter 52. As depicted, the network adapter 52 may communicate with the other components of the computing device 18 via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

The system 10 may be configured to implement a special control request in the filesystem to support creation of a file. In accordance with one embodiment, a file server 16 may be used to implement the special control request. Typically, creation of a file with required attributes in a filesystem by an application involves a sequence of operations executed sequentially on a per file granularity. For each file, it typically involves a creation of a filesystem node, and then one or more calls to set the various file attributes. Each of these operations involve a workflow from application to the filesystem traversing through all required layers of the system, thereby subject to the inherent latency of the system. This can be inefficient in systems with high path length and latency.

In this embodiment of the present invention, the multiple calls from the application to filesystem are replaced with a single special control request that will create the file and also update all the attributes of the file. As a result, the metadata representing the file can be updated just once in the persistent storage.

An embodiment of this special control request could be a standard input/output control, or IOCtl, call to the filesystem. Another embodiment of the special control request could be through a socket channel established between the application and the filesystem.

The system 10 may be configured to convey in the special control request a source of file attributes the special control request should apply onto the file. These attributes could be communicated through the control request, through the attributes of a source file, through a special file, or through some other means.

Nominal metadata attributes could be communicated directly in the special control request. However, any extensive metadata maintained by different filesystems might require an alternate source to be used by the filesystem. In this case, the file attributes could be communicated through a separate file that could act as the source of the attributes the filesystem needs to apply. In accordance with one embodiment, the metadata and attributes are copied by the filesystem directly from the metadata and attributes of a source file accessed using the same filesystem protocol.

The system 10 may be configured to allow batch creation of multiple files through a single special control request. In this embodiment the special control request includes an arbitrary number of files that can be created from that single special control request. The ability to create multiple files in a single control request further helps the high path length/latency systems mentioned above. In accordance with one embodiment, the sources of the metadata and attributes of all the files being created are corresponding source files carrying their respective metadata and attributes.

The system 10 may be configured to make a mass update of the directory manifest with the batch of files created by the single special control request. One of the most critical sequentialized operations involved in creating files in filesystems may be the inclusion of the file in the manifest of the parent directory. To guarantee a consistent view of the directories and files in the filesystem, this operation is typically synchronized, and only one file can be added to the manifest of a directory at one time. This embodiment of the present invention accompanies the creation of many files at once with actively updating the directory manifest all at once to limit that synchronization to a single update of the directory manifest.

The system 10 may be configured to recognize the boundary of the batch of files to be created to be the end of the directory in which the files are being created. In accordance with one embodiment, a filesystem client/computing device 12 may be used to recognize the boundary of the batch of files to be created.

In accordance with one embodiment, the end of a directory is an ideal boundary for an embodiment of the present invention as it tightens up the filesystem behavior with respect to directories.

The system 10 may be configured to recognize the boundary of the batch of files to be created to be a particular total count of files to be created. The number of files handled by a single instantiation of the special control request by an embodiment of the invention is limited for the sake of efficiency and containment of filesystem synchronization and consistency.

The system 10 may be configured to recognize the boundary of the batch of files to be created to be a particular total size of files to be created. The total file size of files handled by a single instantiation of the special control request by an embodiment of the invention is limited for the sake of containing the time to complete the operations.

The system 10 may be configured to returns the success of each file in the batch create request through a return value of the special request, a bitmap returned by the special request, a special output file, or some other means.

The response of the special control request could indicate a success, a failure, or a partial success/failure in creation of one or more files may be shown. One mechanism of response could be to embed this information in the return code of the special control request for the application to interpret.

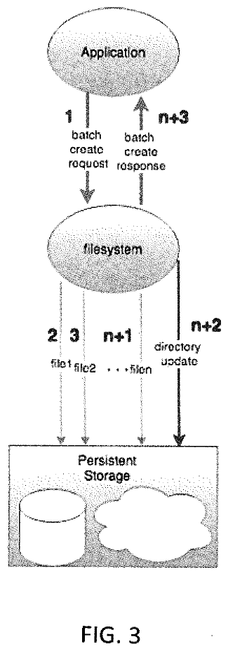

Referring to FIG. 3, a sample workflow of a program modules 44/application within the system 10 for creating ‘n’ files using the special control request provided by the filesystem. As shown in step 1, the program module 44 may send the batch create request to the filesystem with information on number of files, filenames, and the respective attributes. As noted in the embodiments described above, there are multiple mechanisms that can be employed for the application to provide the necessary input for this special control request.

In step 2, the filesystem creates the filesystem node corresponding to file 1 mentioned in the special control request, applies the necessary filesystem attributes, and flushes the updates to the persistent storage. Any failure in creation of the file or application of attributes may be noted in a special return code as specified above.

The above step may be repeated for the remaining files in step 3 through step <n+1>.

After step <n+1> has been done on the last file, step <n+2> updates the parent directory manifest to reflect the files successfully created.

Finally, in step <n+3>, a response is sent to the program module 44 with the status of the create request as detailed above.

The foregoing description is illustrative of particular embodiments of the application, but is not meant to be a limitation upon the practice thereof. The following claims, including all equivalents thereof, are intended to define the scope of the application.

What is claimed is:

1. An electronic file storage system comprising:
a processor;
a memory coupled to the processor, the memory storing program instructions, wherein the program instructions when executed by the processor, causes the processor to:
implement a special control request that creates a file and also update attributes of the file.

2. The electronic file storage system of claim 1, wherein the memory storing program instructions that when executed by the processor, causes the processor to update all attributes of the file in a single call.

3. The electronic file storage system of claim 1, wherein the special control request is one of: a standard input/output control to a filesystem, an IOCtl call to the filesystem or through a socket channel established between an application and a filesystem.

4. The electronic file storage system of claim 1, wherein the memory storing program instructions that when executed by the processor, causes the processor to:
convey in the special control request a source of file attributes the special control request should apply onto the file.

5. The electronic file storage system of claim 4, wherein the source of file attributes is one of a source file, a special file, or similar files.

6. The electronic file storage system of claim 1, wherein the memory storing program instructions that when executed by the processor, causes the processor to:
create multiple files, wherein the single special control request comprises a predefined number of files that can be created from the single special control request.

7. The electronic file storage system of claim 6, wherein the memory storing program instructions that when executed by the processor, causes the processor to:
update each directory manifest for each of the multiple files created.

8. The electronic file storage system of claim 6, comprising an electronic file storage system client, wherein the client comprises:
a client processor;
a client memory coupled to the client processor, the client memory storing program instructions, wherein the program instructions when executed by the client processor, causes the client processor to:
terminate the creation of the multiple files at an end of a directory in which the multiple files are being created.

9. The electronic file storage system of claim 6, comprising an electronic file storage system client, wherein the client comprises:
a client processor;
a client memory coupled to the client processor, the client memory storing program instructions, wherein the program instructions when executed by the client processor, causes the client processor to:
terminate the creation of the multiple files by predefined maximum file number.

10. The electronic file storage system of claim 6, comprising an electronic file storage system client, wherein the client comprises:
a client processor;
a client memory coupled to the client processor, the client memory storing program instructions, wherein the program instructions when executed by the client processor, causes the client processor to:
terminate the creation of the multiple files by a total size of files to be created.

11. The electronic file storage system of claim 6, wherein the memory storing program instructions that when executed by the processor, causes the processor to:
generate a return of success for each of the multiple files.

12. The electronic file storage system of claim 11, wherein the memory storing program instructions that when executed by the processor, causes the processor to:
generate a return of success for each of the multiple files by one of: a return value, a bitmap, a special output file, or like files.

13. An electronic file storage system comprising:
a processor;
a memory coupled to the processor, the memory storing program instructions, wherein the program instructions when executed by the processor, causes the processor to:
implement a special control request that creates at least one file and update attributes of the at least one file in a single call, wherein the special control request is one of: a standard input/output control to a filesystem, an IOCtl call to the filesystem or through a socket channel established between an application and a filesystem.

14. The electronic file storage system of claim 13, wherein the memory storing program instructions that when executed by the processor, causes the processor to:
convey in the special control request a source of file attributes the special control request should apply onto the file.

15. The electronic file storage system of claim 14, wherein the source of file attributes is one of a source file, a special file, or similar files.

16. The electronic file storage system of claim 1, wherein the memory storing program instructions that when executed by the processor, causes the processor to:
create multiple files, wherein the single special control request comprises a predefined number of files that can be created from the single special control request.

17. The electronic file storage system of claim 16, wherein the memory storing program instructions that when executed by the processor, causes the processor to:
update each directory manifest for each of the multiple files created.

18. The electronic file storage system of claim 16, comprising an electronic file storage system client, wherein the client comprises:
a client processor;
a client memory coupled to the client processor, the client memory storing program instructions, wherein the program instructions when executed by the client processor, causes the client processor to:
terminate the creation of the multiple files at one of: an end of a directory in which the multiple files are being created, by a predefined maximum file number, or by a total size of files to be created.

19. The electronic file storage system of claim 16, wherein the memory storing program instructions that when executed by the processor, causes the processor to:
generate a return of success for each of the multiple files.

20. The electronic file storage system of claim 19, wherein the memory storing program instructions that when executed by the processor, causes the processor to:
generate a return of success for each of the multiple files by one of: a return value, a bitmap, a special output file, or like files.
